(19) United States
(12) Patent Application Publication
(10) Pub. No.: US 2016/0231884 A1
(43) Pub. Date: Aug. 11, 2016

(54) SYSTEM AND METHOD FOR MANAGING A WEB RESOURCE IN A BROWSER APPLICATION

(71) Applicant: YANDEX EUROPE AG, Luzern (CH)

(72) Inventors: Andrey Grigorievich PLAKHOV, Sergiev Posad, Moscow region (RU); Nikolay Anatolievich YAREMKO, Ekaterinburg, Sverdlovsk region (RU); Konstantin Pavlovitch GORSKIY, Moscow (RU); Roman Kirillovitch IVANOV, Moscow (RU); Andrey Dmitrievich TARASOV, Barnaul, Altai region (RU)

(73) Assignee: YANDEX EUROPE AG, Luzern (CH)

(21) Appl. No.: 14/917,032

(22) PCT Filed: Oct. 10, 2014
(86) PCT No.: PCT/IB14/65216

§ 371 Date: Mar. 7, 2016

(30) Foreign Application Priority Data
Mar. 31, 2014 (RU) 2014112554

(51) Int. Cl. G06F 3/0482; G06F 3/16; G06F 17/30; G06F 3/0484

(52) U.S. Cl. CPC G06F 3/0482; G06F 3/04845; G06F 3/167; G06F 17/30867

(57) ABSTRACT

There is disclosed a method of displaying a web resource to a user in a browser window of an electronic device. The method is executable at the electronic device. The method comprises: displaying the web resource substantially in an entirety of the browser window; responsive to receiving, via a user interface of the electronic device, an indication of a user desire to execute an action within the browser window, splitting the browser window into a first browser portion and a second browser portion, the first browser portion and the second portion occupying distinct portions of the browser window; displaying within the first browser portion a control panel, the control panel for enabling the user to execute the action within the browser window; displaying within the second browser portion a scaled down unobstructed representation of the web resource.

### CROSS-REFERENCE

The present application claims priority to Russian Patent Application No. 2014112554, filed Mar. 31, 2014, entitled “A SYSTEM AND METHOD FOR MANAGING A WEB RESOURCE IN A BROWSER APPLICATION” the entirety of which is incorporated herein.

### FIELD

The present technology relates to web browsers in general and specifically to a system and method for managing a web resource in a browser application.

### BACKGROUND

Various global or local communications networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

Generally speaking, a given user can access a resource on the communications network by two principle means. The given user can access a particular resource directly, either by typing an address of the resource (typically an URL or Universal Resource Locator, such as www.webpage.com) or by clicking a link in an e-mail or in another web resource. Alternatively, the given user may conduct a search using a search engine to locate a resource of interest. The latter is particularly suitable in those circumstances, where the given user knows a topic of interest, but does not know the exact address of the resource she is interested in.

With the vast amount of information available, user sometimes gets bombarded with information and it is up to the user to sieve through the available information to determine what may be of potential interest to her. For example, let it be assumed that a given user is searching information about computer game, for example, information on the “Silent Hill 2” computer game. If the user were to enter a search term “Silent Hill 2” into a search query interface of a search engine, she would be presented with a total of over 11 million resources, including web resources, images and the like. In order for the user to sieve through such a mountain of information would take a formidable time and effort.

Naturally, modern web search engines have attempted to provide certain tools for the user to sieve through the available information. For example, a Yandex™ browser application presents the user with several tools. The Yandex browser presents the user with a refinement tool, which refinement tool presents certain search refinement choices to the user. In the example of the search for “Silent Hill 2” game, the Yandex browser application may present the user with refinement choices of “game”, “watch”, “mp2”, “book”, “comics” and the like.

Alternatively or additionally, the Yandex browser application can present the user a search results page (SERP) with search results ranked in the order of relevancy—from the most relevant web resource being on top, with the remainder of the web resources being responsive to the search query being ordered (or ranked) in the order of diminishing relevancy to the search request. As such, within the scenario where the user searched for the “Silent Hill 2” game, the most relevant resource in the SERP may be the Wikipedia article about the “Silent Hill 2 game”.

Additionally, some search engine web sites also provide a snippet of information about the web resource—be it a textual summary or a snippet of an image to enable the user to determine if the particular web resources presented in the SERP indeed contains information that the given user is searching for. The user may then click the link associated with this resource, whereby the Yandex browser application will request and display to the user the Wikipedia article on the “Silent Hill 2” game.

Once the user has perused the Wikipedia article on the “Silent Hill 2” game, the user may appreciate that she has not been able to ascertain the information that she was looking for. In this case, the user has a choice to hit a well known “back” button to (at least eventually) return to the web page displaying SERP and peruse another search result.

### SUMMARY

It is an object of the present technology to ameliorate at least some of the inconveniences present in the prior art.

Embodiments of the present technology have been developed based on inventors' appreciating that there exists at least one problem or an area for improvement associated with the prior art solutions. For example, using the above-referenced example of the user searching for the “Silent Hill 2” game information, the user has to peruse back and forth between the search result page and the resources until the user finds the required information. Furthermore, in some circumstances the user may not be even aware of the wealth of related information available out there associated with the web resource that the user is seeking.

According to a first broad aspect of the present technology, there is provided a method of displaying a web resource to a user in a browser window of an electronic device. The method is executable at the electronic device. The method comprises displaying the web resource substantially in an entirety of the browser window; responsive to receiving, via a user interface of the electronic device, an indication of a user desire to execute an action within the browser window, splitting the browser window into a first browser portion and a second browser portion, the first browser portion and the second portion occupying distinct portions of the browser window; displaying within the first browser portion a control panel, the control panel for enabling the user to execute the action within the browser window; displaying within the second browser portion a scaled down unobstructed representation of the web resource.

In some implementations, the method further comprises displaying within the second browser portion, in close proximity to the scaled down unobstructed representation of the web resource, at least one content-specific action tool bar for enabling the user to execute an action with the resource.

In some implementations, the method further comprises displaying within the second browser portion, in close proximity to the scaled down unobstructed representation of the web resource, at least one generic page action tool bar.

In some implementations, the method further comprises:

displaying within the second browser portion, in close proximity to the scaled down unobstructed representation of the web resource, at least one content-specific action tool bar for enabling the user to execute an action with the resource;

displaying within the second browser portion, in close proximity to the scaled down unobstructed representation of the web resource, at least one generic page action tool bar.

In some implementations, the least one content-specific action tool bar comprises an information snippet and an action item portion.

In some implementations, the method further comprises receiving, via a communication network from a server, a trigger for generating the information snippet.

In some implementations, the method further comprises receiving, via a communication network from a server, a trigger for generating the action item portion.

In some implementations, the method further comprises receiving, via a communication network from a server, a trigger for generating the information snippet and the action item portion.

In some implementations, the information snippet comprises a browsing history associated with the web resource.

In some implementations, the method further comprises appreciating the browsing history.

In some implementations, the information snippet comprises a social media information associated with the web resource.

In some implementations, the method further comprises associating the social media information.

In some implementations, the method further comprises receiving, via a communication network from a server, a trigger for generating the least one content-specific action tool bar.

In some implementations, the least one content-specific action tool bar comprises a list of suggested links.

In some implementations, the server is a search engine server and the trigger having been generated by the search engine server based on historical searching patterns with users searching for the content of the web resource.

In some implementations, the server is a search engine server and the trigger having been generated by the search engine based on information received from the web resource, the information being representative of other web resources related to the web resource

The method of claim 15 or 16, wherein the search engine server is further configured to apply ranking logic to the information received from the web resource in order to generate the trigger.

In some implementations, the trigger is received from a host of the web resource.

In some implementations, the trigger has been generated by the host of the web resource based on the category of the web resource.

According to another broad aspect of the present technology, there is provided a method of displaying a web resource to a user in a browser window of an electronic device. The method is executable at a server in communication with the electronic device over a communication network. The method comprises: transmitting to the electronic device a trigger, the trigger being instrumental in causing the electronic device, the electronic device displaying the web resource substantially in an entirety of the browser window to: responsive to receiving, via a user interface of the electronic device, an indication of a user desire to execute an action within the browser window, execute splitting the browser window into a first browser portion and a second browser portion, the first browser portion and the second portion occupying distinct portions of the browser window; execute displaying within the first browser portion a control panel, the control panel for enabling the user to execute the action within the browser window; display within the second browser portion a scaled down unobstructed representation of the web resource.

According to another broad aspect of the present technology, there is provided an electronic device. The electronic device comprises a user input interface for receiving user inputs; a user output interface for providing at least one of visual and audible outputs to the user; a network communication interface for two-way communication over a communications network; and a processor coupled to the user input interface, the user output interface and the network communication interface, the processor being configured to have access to computer readable commands which commands, when executed, cause the processor to execute: displaying the web resource substantially in an entirety of the browser window; responsive to receiving, via a user interface of the electronic device, an indication of a user desire to execute an action within the browser window, splitting the browser window into a first browser portion and a second browser portion, the first browser portion and the second portion occupying distinct portions of the browser window; displaying within the first browser portion a control panel, the control panel for enabling the user to execute the action within the browser window; displaying within the second browser portion a scaled down unobstructed representation of the web resource.

In some implementations, the commands, when executed, are further configured to cause the processor to execute: displaying within the second browser portion, in close proximity to the scaled down unobstructed representation of the web resource, at least one content-specific action tool bar for enabling the user to execute an action with the resource.

In some implementations, the commands, when executed, are further configured to cause the processor to execute: displaying within the second browser portion, in close proximity to the scaled down unobstructed representation of the web resource, at least one generic page action tool bar.

In some implementations, the commands, when executed, are further configured to cause the processor to execute: displaying within the second browser portion, in close proximity to the scaled down unobstructed representation of the web resource, at least one content-specific action tool bar for enabling the user to execute an action with the resource; displaying within the second browser portion, in close proximity to the scaled down unobstructed representation of the web resource, at least one generic page action tool bar.

In some implementations, the least one content-specific action tool bar comprises an information snippet and an action item portion.

In some implementations, the commands, when executed, are further configured to cause the processor to execute: receiving, via a communication network from a server, a trigger for generating the information snippet.

In some implementations, the commands, when executed, are further configured to cause the processor to execute: receiving, via a communication network from a server, a trigger for generating the action item portion.

In some implementations, the commands, when executed, are further configured to cause the processor to execute: receiving, via a communication network from a server, a trigger for generating the information snippet and the action item portion.

In some implementations, the information snippet comprises a browsing history associated with the web resource.

In some implementations, the commands, when executed, are further configured to cause the processor to execute: appreciating the browsing history.

In some implementations, the information snippet comprises a social media information associated with the web resource.

In some implementations, the commands, when executed, are further configured to cause the processor to execute: associating the social media information.

In some implementations, the commands, when executed, are further configured to cause the processor to execute: receiving, via a communication network from a server, a trigger for generating the least one content-specific action tool bar.

In some implementations, the least one content-specific action tool bar comprises a list of suggested links.

In some implementations, the server being a search engine server and the trigger having been generated by the search engine server based on historical searching patterns with users searching for the content of the web resource.

In some implementations, the server being a search engine server and the trigger having been generated by the search engine based on information received from the web resource, the information being representative of other web resources related to the web resource

In some implementations, the search engine server is further configured to apply ranking logic to the information received from the web resource in order to generate the trigger.

In some implementations, the trigger is received from a host of the web resource.

In some implementations, the trigger has been generated by the host of the web resource based on the category of the web resource.

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database.

Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram depicting a system 100, the system 100 being implemented in accordance with non-limiting embodiments of the present technology.

FIG. 2 depicts a screen shot 200, which illustrates one non-limiting embodiment of a browser application 104 executed on an electronic device 102 of the system 100 of FIG. 1.

FIG. 3 depicts a flow chart of a method 300, the method executable at a server 116 of the system 100 of FIG. 1, the method 300 being implemented in accordance with a non-limiting embodiment of the present technology.

### DETAILED DESCRIPTION

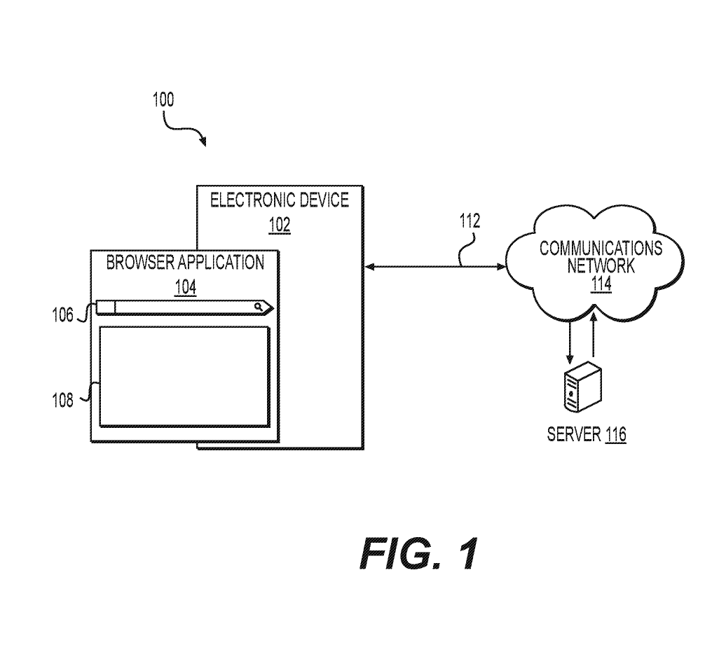

Referring to FIG. 1, there is shown a schematic diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises an electronic device 102. The electronic device 102 is typically associated with a user (not depicted) and, as such, can sometimes be referred to as a “client device”. It should be noted that the fact that the electronic device 102 is associated with the user does not need to suggest or imply any mode of operation—such as a need to log in, a need to be registered or the like.

The implementation of the electronic device 102 is not particularly limited, but as an example, the electronic device 102 may be implemented as a personal computer (desktops, laptops, netbooks, etc.), a wireless electronic device (a cell phone, a smartphone, a tablet and the like), as well as network equipment (a router, a switch, or a gateway). The general implementation of the electronic device 102 is known in the art and, as such, will not be described here at much length. Suffice it to say that the electronic device 102 comprises a user input interface (such as a keyboard, a mouse, a touch pad, a touch screen and the like) for receiving user inputs; a user output interface (such as a screen, a touch screen, a printer and the like) for providing visual or audible outputs to the user; a network communication interface (such as a modem, a network card and the like) for two-way communication over the communications network 114; and a processor coupled to the user input interface, the user output interface and the network communication interface, the processor being configured to execute various routines, including those described herein below. To that end the processor may store or have access to computer readable commands which commands, when executed, cause the processor to execute the various routines described herein.

The electronic device 102 comprises hardware and/or software and/or firmware (or a combination thereof), as is known in the art, to execute a browser application 104. Generally speaking, the purpose of the browser application 104 is to enable the user (not depicted) to access one or more web resources. The browser application 104 has a command interface 106 and the browsing interface 108, both of which are empty as the user has not yet started inputting any web resource addresses or any queries.

The command interface 106 can be implemented as an “omnibox” field—the one incorporating functionality of the field for entering URLs and the field for entering search queries for the search engine to search. In other words, within the depicted embodiment, the user can use the command interface 106 for both entering search queries and URLs. The browsing interface 108 is for displaying to the user either (i) a web resource associated with the URL entered into the command interface 106 or (ii) a search results page (SERP) generated in response to the search query entered in the command interface 106.

The electronic device 102 is coupled to a communications network 114 via a communication link 112. In some non-limiting embodiments of the present technology, the communications network 114 can be implemented as the Internet. In other embodiments of the present technology, the communications network 114 can be implemented differently, such as any wide-area communications network, local-area communications network, a private communications network and the like.

How the communication link 112 is implemented is not particularly limited and will depend on how the electronic device 102 is implemented. Recalling that the electronic device 102 is implemented, in this example, as a laptop, the communication link 112 can be either wireless (such as the Wireless Fidelity, or WiFi® for short, Bluetooth® or the like) or wired (such as an Ethernet based connection).

It should be expressly understood that implementations for the electronic device 102, the communication link 112 and the communications network 114 are provided for illustration purposes only. As such, those skilled in the art will easily appreciate other specific implementational details for the electronic device 102, the communication link 112 and the communications network 114. As such, by no means, examples provided herein above are meant to limit the scope of the present technology.

Also coupled to the communications network is a server 116. The server 216 can be implemented as a conventional computer server. In an example of an embodiment of the present technology, the server 116 can be implemented as a De11™ PowerEdge™ Server running the Microsoft™ Windows Server™ operating system. Needless to say, the server 116 can be implemented in any other suitable hardware and/or software and/or firmware or a combination thereof. In the depicted non-limiting embodiment of present technology, the server 116 is a single server. In alternative non-limiting embodiments of the present technology, the functionality of the server 116 may be distributed and may be implemented via multiple servers.

The implementation of the server 116 is well known. However, briefly speaking, the server 116 comprises a communication interface (not depicted) structured and configured to communicate with various entities (such as the electronic device 102, for example and other devices potentially coupled to the communications network 114) via the communications network 114. The server 116 further comprises at least one computer processor (not depicted) operationally connected with the communication interface and structured and configured to execute various processes to be described herein.

In some embodiments of the present technology, the server 116 can be operated by an operator of a search engine, such as the operator of the Yandex™ search engine available at www.yandex.ru. In alternative embodiments, the server 116 can be operated by any other suitable entity, such as another search engine operator and the like.

In alternative embodiments, the server 116 can be operated by the same entity that has provided the afore-described browser application 104. In alternative embodiments, the server 116 can be operated by an entity different from the one who has provided the afore-mentioned browser application 104.

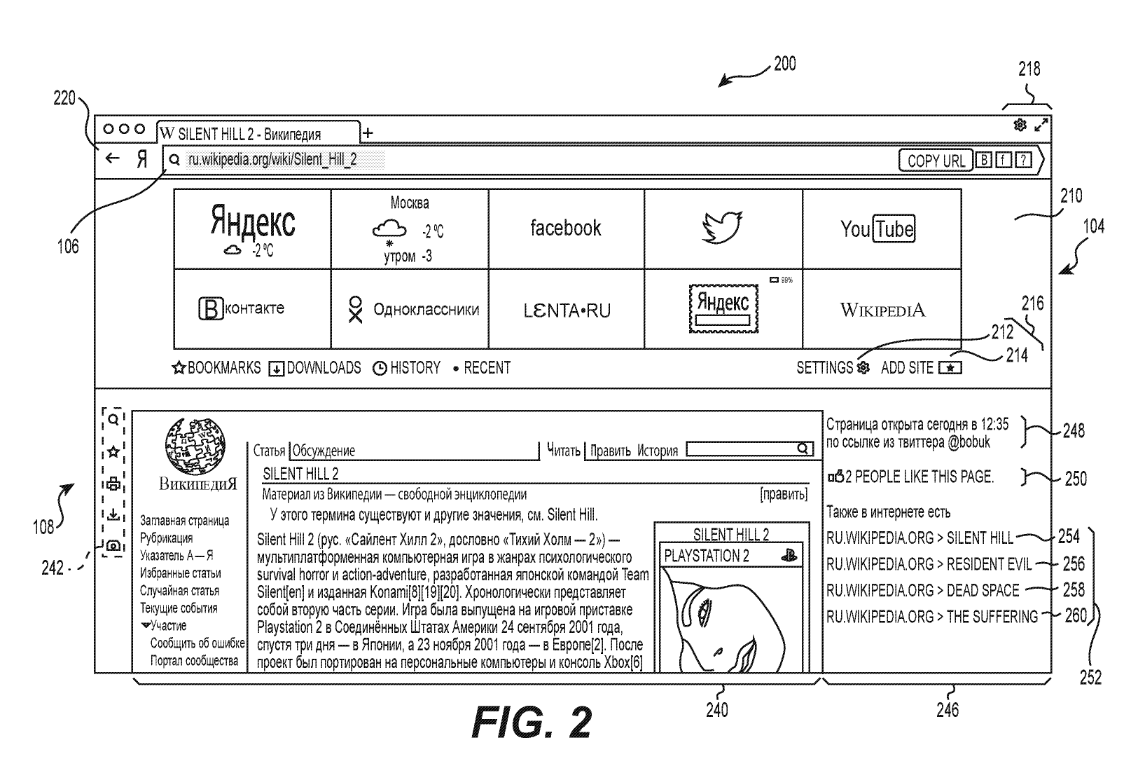

How the browser application 104 is implemented is not particularly limited. One example of the browser application 104 may be embodied as a Yandex™ browser, an example of which is depicted with reference to FIG. 2, which depicts a screen shot 202 of one embodiment of the browser application 104. As previously discussed, the browser application 104 comprises the command interface 106 (implemented as an omnibox) and the browsing interface 108.

Within the embodiment depicted in FIG. 2, the browser application 104 also comprises a control panel 210, the control panel 210 having shortcuts and/or notifications from a number of services. Within the specific example, the services include Yandex™ weather, Moscow weather service, Facebook™, Twitter™, Youtube™, Vkontakte™, Odnoklassniki™, news portal www.lenta.ru, Yandex.Mail™, and Wikipedia. Needless to say that the number and the actual services can vary in the alternative embodiments of the present technology.

Within the specific example, the content of the control panel 210 is generated by the browser application 104 based on the recently visited web resources (for generating the shortcuts and links) and/or services (for generating notifications) to which the user is logged into (or otherwise is authenticated with). In some embodiments, some or all of the content of the control panel 210 can be updated in real or near-real time. For example, the notification from the Odnoklassniki social network provided in control panel 210 can be updated from time to time with the new messages, as they are arrive at the respective server destined for the user of the electronic device 102.

It should be noted that the control panel 210 can be generated in any other manner It should be also noted that the appearance of the control panel 210 can be customized by the user. To that end, there is provided a control panel setting buttons 216. The control panel setting buttons 216 including a settings button 212 and an add site button 214. The add site button 214 can allow the user to customize which services, notifications and bookmarks are shown within the control panel 210.

Briefly to complete the description of the browser application 104 of FIG. 2, the browser application 104 comprises a browser control buttons panel 218. The browser control buttons panel 218 includes the well-known button for minimizing the browser screen, maximizing the browser screen and closing the browser screen (all not numbered). The browser application 104 also includes a conventionally-known back button 220, the back button 220 for allowing the user to go back to previously viewed web resources.

It should be expressly noted that the various details of the implementation of the browser application 104 can be varied or omitted without affecting the scope of implementation of the embodiments of the present technology. It should be also expressly understood that embodiments of the present technology are not limited to the browser environment depicted with the illustration of the browser application 104. Teachings presented herein can be equally applied to the browser application 104 of the prior art (FIG. 1) or any other commercially available or proprietary browsers. As such, a non limiting list of the browsers where embodiments of the present technology can be implemented include: Chrome browser, Safari browser, Mozilla browser, Opera browser and the like.

According to embodiments of the present technology and within the illustration of FIG. 2, the browsing interface 108 includes a browsed page 240. The browsed page 240 shows a resource associated with the URL address entered into the control command interface 106. In the particular example, the URL address entered into the command interface 106 is ru.wikipedia.org/wiki/Silent_Hill_2. Accordingly, the web resource being displayed within the browsed page 240 is the Russian Wikipedia article on the Silent Hill 2 game. It is also noted that displaying of the web resource associated with the browsed page 240 is executed in a scaled down manner (i.e. only a portion of the web resource is visible in FIG. 2). Put another way, the browser window area taken by the browsed page 240, as shown in FIG. 2, does not span all of the available browser window area of the browser application 104.

It should be noted that in the depicted embodiment, the control panel 110 is not overlaid over the browsed page 240. In other words, the control panel 110 is displayed in a first portion of a window of the search application 104 (i.e. first portion of the browser window) and the browsed page 240 is displayed in a second portion of a window of the search application 104 (i.e. second portion of the browser window) and the first portion and the second portion do not overlap therebwteen. Put another way, the control panel 110 does not obstruct the view of the browsed page 240 by overlapping therewith.

It is noted that the view depicted in the screenshot 200 can be entered into from the view of the browsed page 240 in a full screen mode (as is typically seen in a web browser) responsive to receiving an indication of a user desire to execute an action within the browser window. This indication can be received by user indicating her desire via a user interface, such as a mouse, a key board, a touch screen and the like. For example, the indication of the desire to perform an action can be implemented as the user mouse-clicking in the area of the command interface 106. Alternatively, the indication of the desire to perform an action can be implemented as the user right-mouse-clicking in the area of the command interface 106 or any other area of the search application 104. Alternatively, the indication of the desire to perform an action can be implemented as the user entering a pre-determined key stroke pattern (by actuating a combination of keys), a combination of a key and a mouse action, a pre-determined action on a touch screen and the like.

In response to the receipt of such the indication of the user desire to perform an action with the content of the browsed page 240, the search application 104 effectively splits the browser window into a first browser portion and a second browser portion, the first browser portion and the second portion occupying distinct portions of the browser window, as is depicted in the illustration of FIG. 2.

The browsing interface 108 further includes a generic page action tool bar 242 and a content-specific action tool bar 246. The generic page action tool bar 242 includes a number of actions that the user can perform with the web resource displayed in the browsing interface 108. These actions include, in the illustrated embodiment, zooming the view, adding the page to favourites, printing the page, saving the page and taking a snapshot of the screen. It is noted that any other number of types of generic actions can be presented in the generic page action tool bar 242. For the avoidance of doubt, the term “generic action” is meant to denote an action which is the same irrespective of the content of the browsed page 240. In other words, if the content of the browsed page 240 was a CNN news home page, the content of the generic page action tool bar 242 would be the same. Same would apply for any other content potentially displayed in the browsed page 240.

In some embodiments of the present technology, the generic page action tool bar 242 can be modified (i.e. have a different form, have a different number of action buttons, etc) or omitted altogether. Also, it is noted that even though the placement of the generic page action tool bar 242 and the content-specific action tool bar 246 have been depicted to the left and the right, respectively, of the browsed page 240, this needs not be so in every alternative embodiment of the present technology. For example, the generic page action tool bar 242 and the content-specific action tool bar 246 can be reversed. Alternatively, the generic page action tool bar 242 and the content-specific action tool bar 246 can be placed side to side to one side of the browsed page 240. Alternatively, the generic page action tool bar 242 and the content-specific action tool bar 246 can be displayed together or separately above or below (or one above one below) the browsed page 240.

The content-specific action tool bar 246, on the other hand, comprises one or more actions specifically dependent on the content of the browsed page 240. In the specific example being depicted herein, the content-specific action tool bar 246 comprises several components, some of them being of an information snippet type and some of them being of an action item type, both the information snippet and the action item being dependent on the content of the content shown in the browsed page 240.

As such, the content-specific action tool bar 246 comprises a page history snippet 248. The page history snippet 248 provides information about the history of browsing of the content in the browsed page 240. The information presented in the page history snippet 248 can be obtained from either the browsing history of the browser application 104, the browsing history associated with the user maintained at the server 114 or from both. Irrespective of how the page history snippet 248 is obtained, it can be the to depend directly from the content displayed within the displayed page 240.

In the specific illustrated embodiment, the page history snippet 248 contains the following message in Russian: “ [symbol] [symbol] [symbol] 12:35 [symbol] [symbol] ” (or in English: “This page was opened today at 12:35 using a link from Twitter”).

The content-specific action tool bar 246 further includes a social media snippet 250. The social media snippet 250 including information about the number of “likes” in the Facebook™ social network. Namely, in the example provided, the social media snippet 250 includes an indication of two “likes:—namely the “like” symbol of thumbs up and a capture of “2 people like this page”. The content of the social media snippet 250 can be obtained from a social network host where the user of the electronic device 102 is authenticated for example. Irrespective of how the social media snippet 250 is obtained, it can be the to depend directly from the content displayed within the displayed page 240.

The above are examples of the information snippets presented within the content-specific action tool bar 246. What follows are example of the action items potentially present within the content-specific action tool bar 246. The content-specific action tool bar 246 further includes a list of suggested links 252, the list of suggested links enabling the user to select one or more suggested links.

Within the specific embodiment being presented herein, the list of suggested links 252 comprises a first suggested link 254, a second suggested link 256, a third suggested link 258 and a fourth suggested link 260. It should be noted that the number of the suggested links within the list of suggested links 252 within alternative embodiments of the present technology can vary.

Within the depicted embodiment, the first suggested link 254 comprises a link to the Russian Wikipedia article on Silent Hill (the first part of the game). The second suggested link 256 comprises a link to the Russian Wikipedia article on Resident Evil (another computer game in the same genre as Silent Hill II game). The third suggested link 258 comprises a link to the Russian Wikipedia article on Dead Space (another computer game in the same genre as Silent Hill II game). The fourth suggested link 260 comprises a link to the Russian Wikipedia article on The Suffering (another computer game in the same genre as Silent Hill II game).

It is noted that the content of each the list of the suggested links 252 has been generated based on the content of the browsed page 240. It is also noted that each of the list of the suggested links 252 allows the user to perform at least one content-specific action—in this case the action including browsing content related to the content of the browsed page 240. It is noted that the user may not even be aware that she may be interested in the content of the web resources links to which are provided within the list of suggested links 252. In other words, the content of the list of suggested links 252 can be generated and presented to the user of the electronic device 102 without the user expressly indicating her desire to see suggested links or even being aware of the existence of such related material.

How the content of the list of suggested links 252 is generated will now be described in greater details.

In some embodiments of the present technology, the content of the list of suggested links 252 is compiled based on the historical information about other users searches that have accessed the same web resource as the one displayed in the browsed page 240. Recalling that the server 116 can be under the control of a search engine entity, the server 116 can maintain a log (not depicted) of browsed content. In some implementations, upon user consent and authorization, the server 116 maintains a log (not depicted) with content searched for and clicked through by a particular user (for example, storing this information in associated with a user profile registered with the search engine). Alternatively, the server 116 can maintain an anonymized log (not depicted) of various user search history and click through history. Hence, it can be the that the server 116 becomes aware of the historical searching and/or browsing patterns associated with other users searching for or browsing the content of the browsed page 240.

Based on the maintained logs (not depicted) the server 116 can determine certain patterns of search and browsing activity. For example, using machine-learning algorithms, the server 116 can determine the following search pattern: users searching for “purchase air cheap tickets online” also search for “travel insurance policy, cheap”. By the same token, the server can determine the following search pattern: users searching for “Siamese kittens” also search for “newest model of BMW”. It should be noted that based on the log information a number of additional patterns can be developed and ranked based on their relevancy.

By applying these various learned historical search patterns and using our example of the Silent Hill II web site, the server 116 can access the logs (not depicted) and appreciate, based on other users' past searches, what other related (or unrelated for that matter) information other users searching for “Silent Hill II” have also searched for. In the particular example provided herein, the server 116 determines that the most frequently searched terms were for “Silent Hill”, “Resident Evil”, “Dead Space” and “The Suffering”.

In some embodiments of the present technology, rather than simply looking for related searches, the server 116 can further analyze the click through information. The click through information represents information about which search results from a plurality of search results presented to the user in response to a particular search query, the user has selected. In the particular example being illustrated herein, the server 116 may determine that the most clicked through search results was the related Russian Wikipedia article (i.e. Wikipedia article related to, respectively, for “Silent Hill”, “Resident Evil”, “Dead Space” and “The Suffering”). In some embodiments, the server 116 can rank the related resources presented in the list of suggested links 252. The ranking can be executed based on historical information associated with other users browsing for the content of the browsed page 240. Alternatively or additionally, the server 116 can take into account personalized features known about the user of the electronic device 102.

In alternative embodiments, rather than looking for the most clicked through search result information, the server 116 can determine suggested links based on “related resources”. For example, once the server 116 has determined that the related searches to “Silent Hill II” are searches for “Silent Hill”, “Resident Evil”, “Dead Space” and “The Suffering”, the server 116 can analyze the type of the content of the browsed page 240.

In this particular example, the server 116 can determine that the type of content of the browsed page 240 is “Wikipedia article”. The server 116 can then select those ones of the historical search results from the search results responsive to historic search queries for “Silent Hill”, “Resident Evil”, “Dead Space” and “The Suffering” which are associated with the same type of the content (i.e. in this case—Wikipedia articles).

In alternative embodiment of the present technology, the content of the list of suggested links 252 can be generated based on the information available from the web resource associated with the browsed page 240. For example, continuing with the present example, the Wikipedia article about Silent Hill II contains a section on related articles in the same category. For example, Wikipedia categorizes Silent Hill II in “Psychological horror games”. The server 116 can receive an indication of other articles in the same category. In some embodiments of the present technology, the server 116 can further apply its logic and routines (such as those described above based on past search patterns) to retrieve the most relevant or the most popular from those listed in the related category by the web resource associated with the browsed page 240.

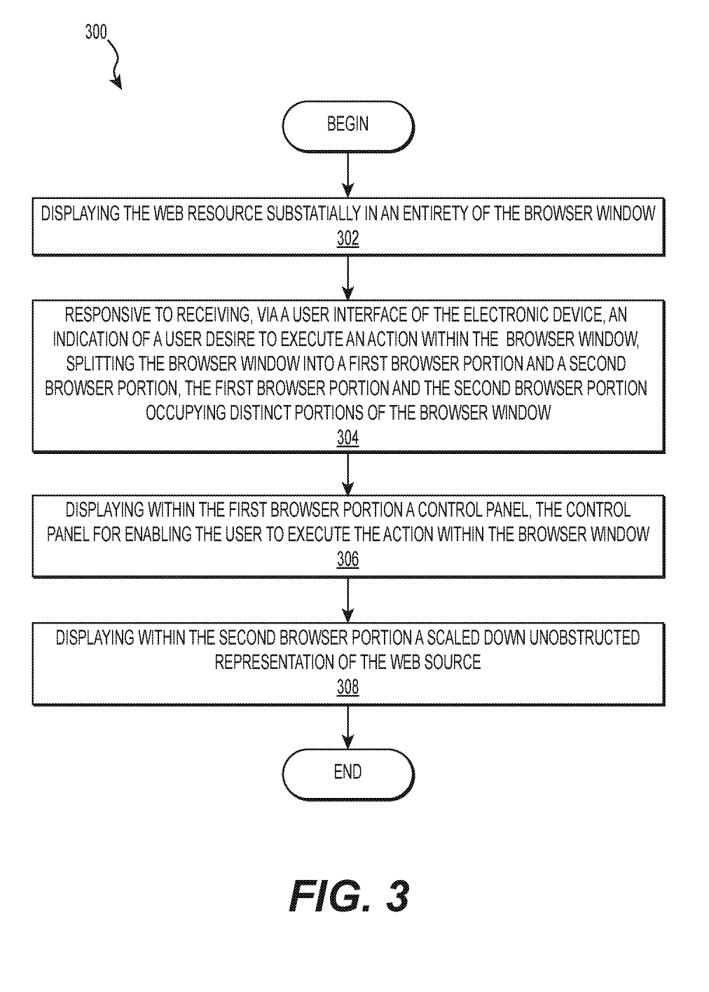

Given the architecture of the system 100 described with reference to FIG. 1 and the examples provided with reference to FIG. 2, it is possible to execute a method of displaying a web resource. With reference to FIG. 3, there is depicted a method 300, the method 300 being implemented in accordance with a non-limiting embodiment of the present technology. Within the embodiments of the present technology, the method 300 can be conveniently executed at the server 116. To that extent, the server 116 comprises non-transient computer readable medium containing computer executable instructions, which instructions when executed are configured to cause the server 116 to execute the steps of the method 300.

Step 302—Displaying the Web Resource Substantially in an Entirety of the Browser Window

The method 300 starts at step 302 the electronic device 102 displays the web resource substantially in an entirety of the browser window of the browser application 104. Within embodiments of the present technology and using the above examples, the electronic device displays, as part of the browser application 104 the web resource that the user is desirous of browsing. In this example (but not shown in the illustrations) the browser application 104 can display the browsed page 240 (i.e. Russian Wikipedia article on Silent Hill II) game in substantially the entirety of the browser window—i.e. the real estate of the browser window that is occupied by the control panel 210 and the browsed page 240 in FIG. 2).

The method 300 then proceeds to execution of step 304.

Step 304—Responsive to Receiving, Via a Aser Interface of the Electronic Device, an Indication of a User Desire to Execute an Action Within the Browser Window, Splitting the Browser Window into a First Browser Portion and a Second Browser Portion, the First Browser Portion and the Second Portion Occupying Distinct Portions of the Browser Window

Next, at step 304, the electronic device 102, responsive to receiving, via a user interface of the electronic device, an indication of the user desire to execute an action within the browser window, splits the browser window into a first browser portion and a second browser portion, the first browser portion and the second portion occupying distinct portions of the browser window.

More specifically and as has been previously alluded to with reference to FIG. 2, the browser window is split into two distinct portions that are not overlaid therebetween.

Also, as has been alluded to above, the indication of the user desire to execute an action with the browser window is not particularly limited and can be implemented as described above, including a combination of the various examples provided above, as well as other alterative means conceivable to those of skill in the art, who have appreciated teachings of embodiments of the present technology.

The method 300 then proceeds to execution of step 306.

Step 306—Displaying Within the First Browser Portion a Control Panel, the Control Panel for Enabling the User to Execute the Action Within the Browser Window

Next, at step 306 the electronic device 102 displays within the first browser portion the control panel 210, the control panel 210 for enabling the user to execute the action within the browser window.

The method than proceeds to execution of step 308.

Step 308—Displaying Within the Second Browser Portion a Scaled Down Unobstructed Representation of the Web Resource

Next, at step 308, the electronic device displays within the second browser portion a scaled down unobstructed representation of the web resource (i.e. the browsed window 240).

In some embodiments of the present technology, as part of executing step 308, the electronic device 102 is further configured to display, within the second browser portion, in close proximity to the scaled down unobstructed representation of the web resource, at least one content-specific action tool bar 246 for enabling the user to execute an action with the web resource.

The electronic device 102 can further be configured to displaying within the second browser portion, in close proximity to the scaled down unobstructed representation of the web resource, at least one generic page action tool bar 242. It should be recalled that the display of the at least one generic page action tool bar 242 is optional and can be omitted.

In some embodiments of the present technology, as part of executing step 308, the method 300 further includes a step of receiving, via the communication network 114 from the server116, a trigger for generating the at least a portion of the content-specific action tool bar 246. The content of the content-specific action tool bar 246 can be of the information snippet type or the action item type. Several examples how such trigger can be generated have been explained above.

In some specific implementations, the content-specific action tool bar comprises the list of suggested links 252. As has been alluded to above, the content of the list of suggested links 252 can be generated using several approaches.

For example, the content of the list of suggested links 252 can be generated, in those embodiments where the server 116 is under control or otherwise has access to a search engine, by means of analyzing historical searching patterns with users searching for the content of the web resource. Alternatively, the content of the list of suggested links 252 can be generated based on analyzing information received from the web resource, the information being representative of other web resources related to the web resource.

In some embodiments, the individual links within the list of suggested links 252 have been ranked in an order.

In some embodiments, the browser application 104 reverts back to the display of the full screen of the browsed page 240. In some embodiments of the present technology, the browser application 104 reverts to the display of the full screen of the browsed page 240 automatically, upon user completing at least one action using either the includes generic page action tool bar 242 and the content-specific action tool bar 246.

Alternatively, the browser application 104 reverts to the display of the full screen of the browsed page 240 automatically, upon user completing a pre-determined number of actions using either the includes generic page action tool bar 242 and the content-specific action tool bar 246.

Alternatively, the browser application 104 reverts to the display of the full screen of the browsed page 240 automatically, upon user completing a pre-determined number of actions using the content-specific action tool bar 246. Alternatively, the browser application 104 reverts to the display of the full screen of the browsed page 240 automatically, upon user indicating her desire to do so. The user can indicate her desire to return to the full display by pressing the ESC button, as an example.

Naturally, the user can indicate her desire to return to the full screen display using any other button, a combination of key strokes, an action using a touch screen or a mouse, actuating a graphical button on the screen and the like.

In some embodiments of the present technology, a server-side method of displaying a web resource to a user in a browser window of an electronic device 102 can be provided. The method is executable at the server 116 in communication with the electronic device 102 over the communication network 114. The method comprises: transmitting to the electronic device a trigger, the trigger being instrumental in causing the electronic device, the electronic device displaying the web resource substantially in an entirety of the browser window to:

(i) responsive to receiving, via a user interface of the electronic device, an indication of a user desire to execute an action within the browser window, execute splitting the browser window into a first browser portion and a second browser portion, the first browser portion and the second portion occupying distinct portions of the browser window;

(ii) execute displaying within the first browser portion a control panel, the control panel for enabling the user to execute the action within the browser window;

(iii) to display within the second browser portion a scaled down unobstructed representation of the web resource.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of displaying a web resource to a user in a browser window of an electronic device, the method executable at the electronic device, the method comprising:
displaying the web resource substantially in an entirety of the browser window;
responsive to receiving, via a user interface of the electronic device, an indication of a user desire to execute an action within the browser window, splitting the browser window into a first browser portion and a second browser portion, the first browser portion and the second portion occupying distinct portions of the browser window;
displaying within the first browser portion an interactive control panel, the control panel for enabling the user to execute the action within the browser window; said interactive control panel having been generated by the browser application based at least in part on a browsing history;
displaying within the second browser portion a scaled down unobstructed representation of the web resource.

2. The method of claim 1, further comprising displaying within the second browser portion, in close proximity to the scaled down unobstructed representation of the web resource, at least one content-specific action tool bar for enabling the user to execute an action with the resource.

3. The method of claim 1, further comprising displaying within the second browser portion, in close proximity to the scaled down unobstructed representation of the web resource, at least one generic page action tool bar.

4. The method of claim 1, further comprising:
displaying within the second browser portion, in close proximity to the scaled down unobstructed representation of the web resource, at least one content-specific action tool bar for enabling the user to execute an action with the resource;
displaying within the second browser portion, in close proximity to the scaled down unobstructed representation of the web resource, at least one generic page action tool bar.

5. The method of claim 2, wherein the least one content-specific action tool bar comprises an information snippet and an action item portion.

6. The method of claim 5, further comprising receiving, via a communication network from a server, a trigger for generating the information snippet.

7. The method of claim 5, further comprising receiving, via a communication network from a server, a trigger for generating the action item portion.

8. The method of claim 5, further comprising receiving, via a communication network from a server, a trigger for generating the information snippet and the action item portion.

9. The method of claim 5, wherein the information snippet comprises a browsing history associated with the web resource.

10. The method of claim 9, further comprising appreciating the browsing history.

11. The method of claim 5, wherein the information snippet comprises a social media information associated with the web resource.

12. (canceled)

13. The method of claim 2, further comprising receiving, via a communication network from a server, a trigger for generating the least one content-specific action tool bar.

14. The method of claim 13, wherein the least one content-specific action tool bar comprises a list of suggested links.

15. The method of claim 14, the server being a search engine server and the trigger having been generated by the search engine server based on historical searching patterns with users searching for the content of the web resource.

16. The method of claim 14, the server being a search engine server and the trigger having been generated by the search engine based on information received from the web resource, the information being representative of other web resources related to the web resource

17. The method of claim 15, claim 15 or 16, wherein the search engine server is further configured to apply ranking logic to the information received from the web resource in order to generate the trigger.

18. The method of claim 14, wherein the trigger is received from a host of the web resource.

19. The method of claim 18, wherein the trigger has been generated by the host of the web resource based on the category of the web resource.

20. A method of displaying a web resource to a user in a browser window of an electronic device, the method executable at a server in communication with the electronic device over a communication network, the method comprising:
transmitting to the electronic device a trigger, the trigger being instrumental in causing the electronic device, the electronic device displaying the web resource substantially in an entirety of the browser window to:
responsive to receiving, via a user interface of the electronic device, an indication of a user desire to execute an action within the browser window,
execute splitting the browser window into a first browser portion and a second browser portion, the first browser portion and the second portion occupying distinct portions of the browser window;
execute displaying within the first browser portion an interactive control panel, the control panel for enabling the user to execute the action within the browser window; said interactive control panel having been generated by the browser application based at least in part on a browsing history;
display within the second browser portion a scaled down unobstructed representation of the web resource.

21. An electronic device comprising:
a user input interface for receiving user inputs;
a user output interface for providing at least one of visual and audible outputs to the user;
a network communication interface for two-way communication over a communications network; and
a processor coupled to the user input interface, the user output interface and the network communication interface, the processor being configured to have access to computer readable commands which commands, when executed, cause the processor to execute:
displaying the web resource substantially in an entirety of the browser window;
responsive to receiving, via a user interface of the electronic device, an indication of a user desire to execute an action within the browser window, splitting the browser window into a first browser portion and a second browser portion, the first browser portion and the second portion occupying distinct portions of the browser window;
displaying within the first browser portion interactive control panel, the control panel for enabling the user to execute the action within the browser window; said interactive control panel having been generated by the browser application based at least in part on a browsing history;
displaying within the second browser portion a scaled down unobstructed representation of the web resource.

22-39. (canceled)
